(19) United States
(12) Patent Application Publication
(10) Pub. No.: US 2012/0274702 A1
(43) Pub. Date: Nov. 1, 2012

(54) ANGLED SCRAPER

(76) Inventors: Wee Teck Woon, Singapore (SG); Kok Leong Law, Singapore (SG)

(21) Appl. No.: 13/094,501

(22) Filed: Apr. 26, 2011

(51) Int. Cl. B41J 2/165

(52) U.S. Cl. 347/33

(57) ABSTRACT

A cleaning system for an inkjet printhead is disclosed. The cleaning system has a wiper and a scraper. The wiper has a wiper blade that has a top edge that is scraped by the bottom edge of the scraper when the wiper moves past the scraper. The top edge of the wiper blade forms and angle with respect to the bottom edge of the scraper.

### BACKGROUND

The sound generated by inkjet printers from the time a print job is started to the time the job is completed generates different acoustic experiences for the user. In general, the sounds produced during printing are deemed more acceptable than the sounds produced before or after printing. These non-printing sounds are mostly attributed to the noise generated by a wiper as it traverses across the inkjet printhead and the scraper. Wipers are used to clean the nozzles in the inkjet printhead between print jobs. Scrapers are used in an inkjet service station to maintain the cleanliness of the wipers. The wipers are bent as they are cleaned by the scrapers. Noise is generated when the wiper blades are released from the scraper as wiper passes under the scraper.

### BRIEF DESCRIPTION OF THE DRAWINGS

FIG. 1A is an isometric top view of a wiper 100 in an example embodiment of the invention.

FIG. 1B is an isometric top view of a scraper 130 in an example embodiment of the invention.

FIG. 2A-2C is a plurality of side views showing a traditional wiper/scraper design.

FIG. 3 is a top view of a scraper/wiper design 300 in an example embodiment of the invention.

FIG. 4 is a top view of a wiper 400 in an example embodiment of the invention.

### DETAILED DESCRIPTION

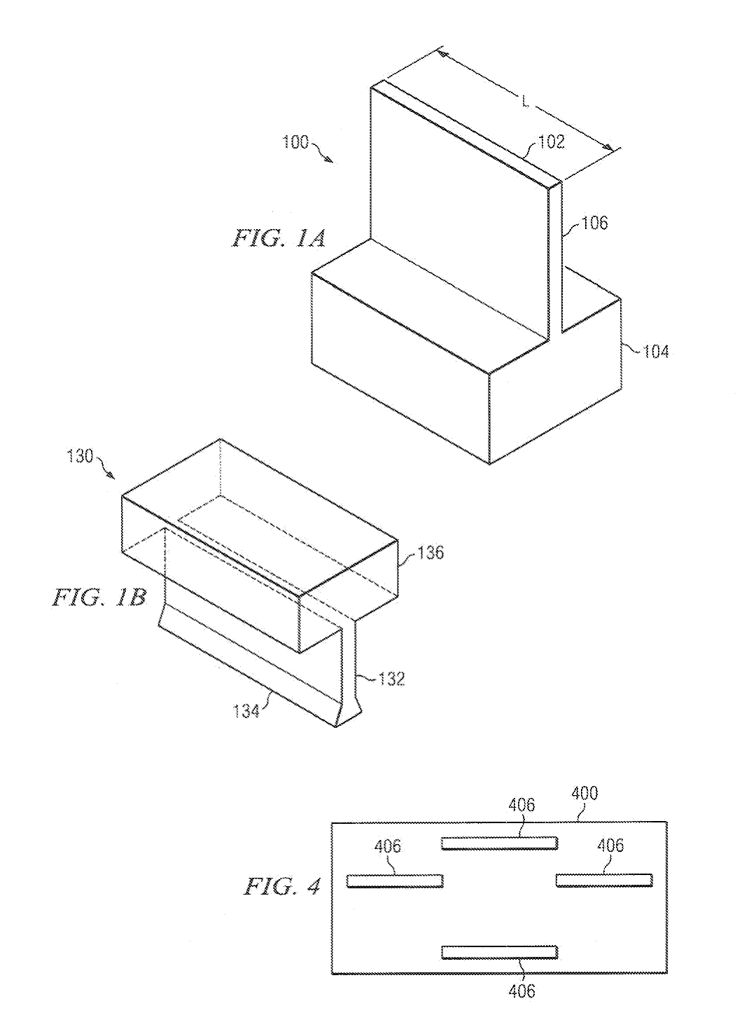

FIGS. 1-4, and the following description depict specific examples of the invention. For the purpose of teaching inventive principles, some conventional aspects have been simplified or omitted. Those skilled in the art will appreciate variations from these examples that fall within the scope of the invention. The features described below can be combined in various ways to form multiple variations of the invention. As a result, the invention is not limited to the specific examples described below, but only by the claims and their equivalents.

FIG. 1A is an isometric top view of a wiper 100 in an example embodiment of the invention. Wiper 100 comprised base 104 and wiper blade 106. Wiper blade 106 has a top edge 102 running along the length L of wiper blade 106. Wiper blade 106 is fabricated from a flexible material. FIG. 1B is an isometric top view of a scraper 130 in an example embodiment of the invention. Scraper 130 comprised base 136 and scraper blade 132. Scraper blade 132 has a bottom edge 134 running along the length of scraper blade 132. Scraper blade 132 is fabricated from a stiff material.

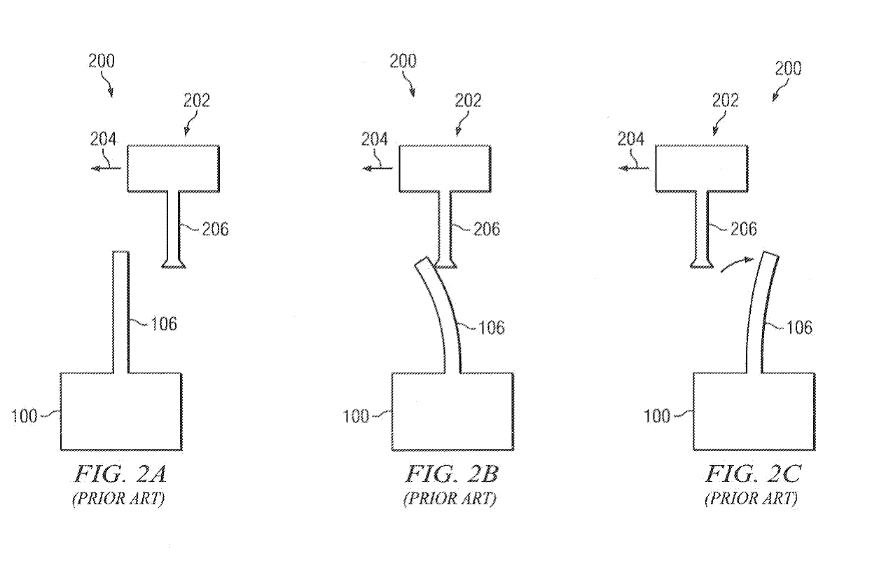

In a traditional wiper/scraper design, the long top edges of the wiper blades and bottom edges of the scraper are parallel with each other and the scrapers travel perpendicular to the long edges. FIG. 2 is a plurality of side views showing a traditional wiper/scraper design. In FIG. 2A wiper 100 is positioned to the left of scraper 202. The wiper blade 106 is parallel to the scraper blade 206. Scraper 202 is configured to move past wiper 100 in the direction of arrow 204. The bottom edge of scraper blade 206 extends downwards below the top of wiper blade 106. As scraper 202 moves past wiper blade 106, the bottom edge of scraper blade 206 hits and deflects the top of wiper blade 106 (see FIG. 213). Because the wipers and scrapers are parallel with each other the full length of the wiper blade is engaged with the scraper as the scraper moves over the wiper. As the scraper moves past the wiper, the full length of the wiper is released (see FIG. 2C) essentially at the same time. Because the full length of the wiper blades is released at the same time, a loud slapping sound can be generated. In other example embodiments, the scraper may be stationary and the wiper will move past the scraper.

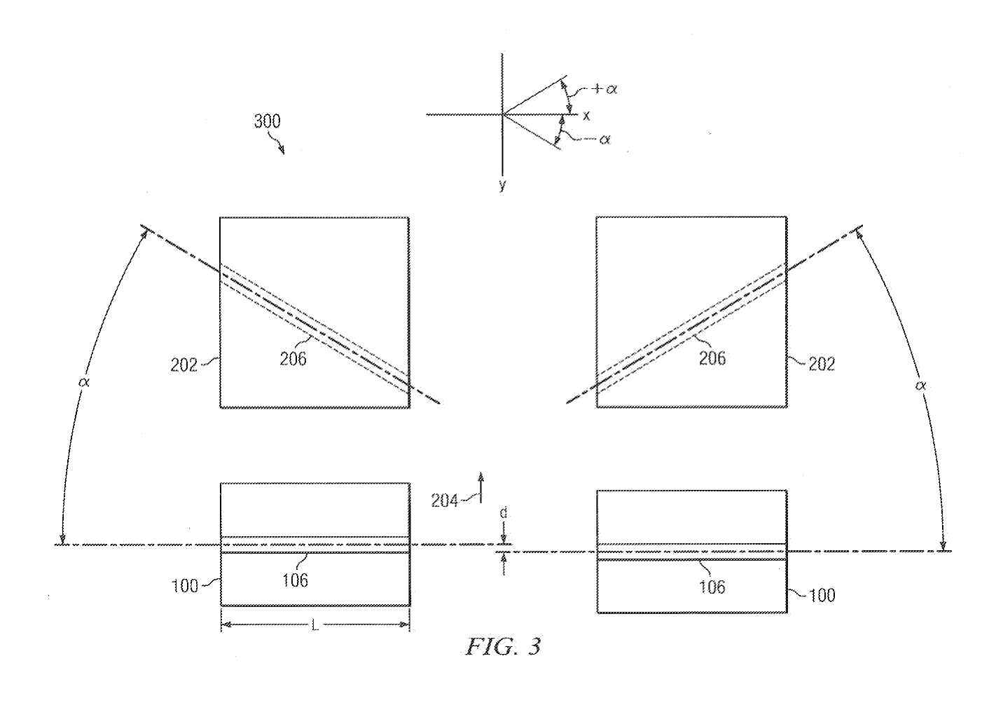

In one example embodiment of the invention, the scraper edge is positioned at an angle with respect to the wiper blade. This angled approach allows for a delayed and staggered released of the wiper blade from the scraper, thus reducing the noise generated. FIG. 3 is a top view of a scraper/wiper design 300 in an example embodiment of the invention. Scraper/wiper design 300 comprises two wipers 100 and two scrapers 202. In one example embodiment of the invention, one wiper may be for a color printhead and the other wiper may be for a black printhead. The two wipers 100 are spaced apart with the wiper blades 106 aligned parallel to one another along the X axis. In one example embodiment of the invention, the two wiper blades 106 may be offset from each other by distance d.

The two scrapers 202 are positioned side by side and are aligned with the wipers in the x axis. The two wipers are configured to move along the Y axis (as shown by arrow 204) such that the wipers pass under the scraper blades 206. Each of the scrapers 202 has a scraper blade 206 formed at an angle α with respect to the wiper blades 106. In one example embodiment of the invention, one scraper blade will make a positive angle α with respect to the wiper blades, and the other scraper blade will make a negative angle α with respect to the wiper blades. In this way the scraper blades will be angled such that the scraper blades are not parallel. Using scraper blades angled in opposite directions will help to minimize any force generated in the X axis as the scraper blades 206 scrape the wiper blades 106.

Because the scraper blades are angled with respect to the wiper blades, the wiper blades will be not be release by the scrapers along the full length L of the wiper blades at the same time. This will reduce the amount of noise created as the wiper blades are released. In one example embodiment of the invention, the angle α is between 0.5 and 15 degrees. In another example embodiment of the invention, angle α is 5 degrees.

When distance d is non-zero and the wiper blades are offset from one another, one wiper blade will be completely released before the other wiper blade is completely released. This will also help to minimize the nose created when the wiper blades are released. In one example embodiment of the invention, the distance d is between 0.5 and 20 mm. In another example embodiment of the invention, distance d is 2.1 mm. In some example embodiments of the invention, the wiper blades may not be offset from one another, but the leading edge of the two scrapers may be offset from one another. This would have the same effect as having the wiper blades offset from one another.

In some example embodiments of the invention, each wiper may have multiple wiper blades. FIG. 4 is a top view of a wiper 400 in an example embodiment of the invention. Wiper 400 has multiple wiper blades 406. In one example embodiment of the invention, one scraper blade will be used to scrape all the different wiper blades. In other embodiments, different scraper blades may be used for each wiper blade.

What is claimed is:

1. A cleaning system for an inkjet printhead, comprising:
a first scraper with a scraper blade, the scraper blade having a bottom edge;
a first wiper with at least one blade, the at least one blade having a top edge, the top edge parallel with a first axis, the first wiper positioned to move under the first scraper in a direction perpendicular to the first axis, the bottom edge of the first scraper positioned to scrape the top edge of the at least one blade of the first wiper when the first wiper movers under the first scraper, the bottom edge of the first scraper forming a second axis; and
wherein the first axis and the second axis are not parallel but form a first angle with respect to each other.

2. The cleaning system for an inkjet printhead of claim 1, wherein the first angle between the first axis and the second axis is between 0.5 and 20 degrees.

3. The cleaning system for an inkjet printhead of claim 1, wherein the first angle between the first axis and the second axis is 5 degrees.

4. The cleaning system for an inkjet printhead of claim 1, further comprises:
a second scraper with a second scraper blade, the second scraper blade having a bottom edge;
a second wiper with at least one blade, the at least one blade having a top edge, the top edge parallel with the first axis, the second wiper positioned to move under the second scraper in a direction perpendicular to the first axis, the bottom edge of the second scraper positioned to scrape the top edge of the at least one blade of the second wiper when the second wiper movers under the second scraper, the bottom edge of the second scraper forming a third axis; and
wherein the first axis forms a second angle with respect to the third axis.

5. The cleaning system for an inkjet printhead of claim 4, wherein the first angle and the second angle are equal in magnitude but opposite in sign such that the second axis and the third axis are not parallel.

6. The cleaning system for an inkjet printhead of claim 5, wherein the first angle is 5 degrees and the second angle is −5 degrees.

7. The cleaning system for an inkjet printhead of claim 4, wherein the at least one blade of the first wiper is offset from the at least one blade of the second wiper by a distance d in a direction perpendicular to the first axis.

8. The cleaning system for an inkjet printhead of claim 7, wherein distance d is between 0.01 mm and 10 mm.

9. The cleaning system for an inkjet printhead of claim 7, wherein distance d is 2.1 mm.

10. A cleaning system for an inkjet printhead, comprising:
a first wiper with at least one blade, the at least one blade having a top edge, the top edge forming a first axis;
a means for scraping the top edge of the at least one blade, the means for scraping angled with respect to the top edge of the at least one blade.

11. A cleaning system for an inkjet printhead, comprising:
a first wiper with a plurality of wiper blades where each of the plurality of wiper blades has a top edge and each of the plurality of top edges are parallel with a first axis, the first wiper configured to move under a first scraper in a direction perpendicular to the first axis;
, the first scraper having a bottom edge positioned to scrape the top edges of the plurality of wiper blades when the first wiper movers under the first scraper, the bottom edge of the first scraper forming an angle with respect to the first axis.

12. The cleaning system for an inkjet printhead of claim 11, further comprising:
a second wiper with a second plurality of wiper blades where each of the second plurality of wiper blades has a top edge and each of the plurality of top edges are parallel with the first axis, the first wiper configured to move under a second scraper in a direction perpendicular to the first axis;
, the second scraper having a bottom edge positioned to scrape the top edges of the second plurality of wiper blades when the second wiper movers under the second scraper, the bottom edge of the second scraper forming the negative angle with respect to the first axis.
